(19) United States
(12) Patent Application Publication
(10) Pub. No.: US 2010/0294437 A1
(43) Pub. Date: Nov. 25, 2010

(54) BARRIER SYSTEMS WITH PROGRAMMABLE ACCELERATION PROFILE AND AUTO-RETRIES FOR PRESSURED EGRESS

(76) Inventor: Curtis P. Gonzales, Eagle, ID (US)

Correspondence Address: PERKINS COIE LLP;PATENT-SEA, P.O. BOX 1247, SEATTLE, WA, 98111-1247, US

(21) Appl. No.: 12/769,409

(22) Filed: Apr. 28, 2010

Related U.S. Application Data
(60) Provisional application No. 61/173,938, filed on Apr. 29, 2009.

(51) Int. Cl. E05F 15/20; E06B 3/34; G05B 15/02

(52) U.S. Cl. 160/7; 160/405; 49/506; 700/275

(57) ABSTRACT

Barrier systems and associated methods, including vapor and/or fire barrier systems, are disclosed herein. One aspect of the invention is directed toward a barrier system that includes a barrier that is moved between a deployed position and a retracted position. The flexible barrier is configured to prevent migration of smoke or other harmful vapor, but to allow egress through the barrier upon request. A pressure gradient across the barrier can cause the barrier to bow and inhibit raising the barrier. A control system directs a drive system to stop raising the barrier, wait a predetermined time, and then raise the barrier again. In some embodiments, the barrier can be returned toward the deployed position before raising the barrier again.

### CROSS REFERENCE TO RELATED APPLICATIONS

This application claims priority to and incorporates herein by reference thereto U.S. Provisional Patent Application No. 61/173,938, titled “BARRIER SYSTEMS WITH PROGRAMMABLE ACCELERATION PROFILE AND AUTO-RETRIES FOR PRESSURED EGRESS,” filed Apr. 29, 2009.

### TECHNICAL FIELD

Embodiments of the present disclosure relate to barrier systems and associated methods, including vapor and/or fire barrier systems.

### BACKGROUND

Smoke, fumes, and noxious gasses can be very dangerous to occupants during a building fire. It is well known that many fire-related deaths are the result of smoke inhalation. During a fire, or an event where dangerous gases may be present, fumes are likely to travel very quickly through paths that offer little resistance. Paths such as elevator shafts are often well drafted and provide an excellent avenue by which smoke and other dangerous gases can rapidly travel to otherwise unaffected areas of a building. To prevent such a migration of dangerous gases, many devices and assemblies have been designed to limit the dispersal of such fumes by cutting off possible paths or openings. Examples of such devices are smoke screen assemblies disclosed in U.S. Pat. No. 5,383,510, entitled APPARATUS AND METHOD FOR RAPIDLY AND RELIABLY SEALING OFF CERTAIN OPENINGS IN RESPONSE TO SMOKE, NOXIOUS FUMES OR CONTAMINATED AIR, issued Jan. 24, 1995; U.S. Pat. No. 5,195,594, entitled APPARATUS AND METHOD FOR RAPIDLY AND RELIABLY SEALING OFF CERTAIN EXIT AND ENTRANCE WAYS IN RESPONSE TO SMOKE OR FIRE, issued Mar. 23, 1993; U.S. Pat. No. 7,000,668, entitled SYSTEM AND METHOD FOR SEALING OPENINGS IN RESPONSE TO SMOKE, NOXIOUS FUMES, OR CONTAMINATED AIR USING A ROLL-DOWN BARRIER, issued Feb. 21, 2006; U.S. Pat. No. 7,028,742, entitled SYSTEM AND METHOD FOR SEALING OPENINGS IN RESPONSE TO SMOKE, NOXIOUS FUMES, OR CONTAMINATED AIR USING A ROLL-DOWN BARRIER, issued Apr. 18, 2006; U.S. Patent Application No. 2006/0226103, entitled CLOSING MEMBER CONTROL SYSTEMS, INCLUDING DOOR CONTROL SYSTEMS FOR BARRIER HOUSINGS, AND ASSOCIATED METHODS, filed Oct. 12, 2006; U.S. Provisional Patent Application No. 61/164,876, entitled BARRIER SYSTEMS AND ASSOCIATED METHODS, INCLUDING VAPOR AND/OR BARRIER SYSTEMS WITH MANUAL EGRESS, filed Mar. 30, 2009; and U.S. patent application Ser. No. 12/750,552, entitled BARRIER SYSTEMS AND ASSOCIATED METHODS, INCLUDING VAPOR AND/OR BARRIER SYSTEMS WITH MANUAL EGRESS, filed Mar. 30, 2010; each of which is incorporated herein by reference in its entirety.

### SUMMARY

This application discloses a barrier system and related methods that overcome drawbacks experienced by the prior art and provide other benefits. In one embodiment, a barrier system comprises a flexible barrier having a leading edge, a trailing edge, and two side edges. The barrier is configured to deploy across a passage to divide the passage into a first region and a second region to inhibit migration of vapor through the passage. Guide elements engage the two side edges to guide the flexible barrier toward a deployed position across the passage. A drive mechanism is coupled to the flexible barrier and is configured to deploy and retract the flexible barrier, wherein the drive mechanism draws electrical current to move the flexible barrier to and from the deployed position, and wherein the electrical current drawn by the drive mechanism is related to a motion-resistance force opposing barrier movement. A control system is operatively coupled to the drive mechanism and is configured to receive an egress request. The control system is configured to activate the drive mechanism to retract the flexible barrier away from the deployed position in response to the egress request. A current limit monitor is coupled to the control system and is configured to monitor the current drawn by the drive mechanism, wherein the control system is configured to stop movement of the flexible barrier if the electrical current drawn by the drive mechanism exceeds a threshold value related to the motion-resistant force. The control system waits a predetermined time period before reactivating the drive mechanism resuming movement of the flexible barrier.

In other embodiments, the system comprises a manually operated switch remote from the barrier and configured to provide an egress request signal to the control system, wherein the switch, when activated, transmits the egress request signal to the control system. The barrier system is further configured such that after waiting the predetermined time period, the control system reversed direction of the drive mechanism to move the flexible barrier toward a deployed position for a selected duration, and then reverses the direction of the drive mechanism and attempts to retract the barrier away from the deployed position. The predetermined time period can be between approximately 1 and 2 seconds. In other embodiments, the barrier is configured to be positioned in a wall adjacent to a generally vertical passageway and is configured to deploy generally horizontally such that the leading edge contacts an opposing wall when in the deployed position.

Another embodiment provides a method of permitting egress through a flexible barrier deployed in a passageway to inhibit the migration of vapor through the passageway, wherein the barrier divides the passageway between a first and a second region. The method comprises receiving an egress request to move the barrier toward a retracted position, moving the barrier toward the retracted position with a drive mechanism in response to the egress request, monitoring a current level in the drive mechanism, stopping the drive mechanism if the current level exceeds a predetermined threshold, waiting a predetermined time period; and resuming the drive mechanism for moving the barrier toward the retracted position. In one embodiment the method includes, after waiting the predetermined time period, repeating moving the barrier toward the retracted position, monitoring the current level, stopping movement of the barrier if the current level exceeds a predetermined threshold, incrementing a counter for each repetition, and ceasing the repetition when the counter reaches a predetermined limit.

Another embodiment includes a method for retracting a pressurized vapor barrier from a passageway. The method comprises receiving an egress request from an external source, retracting the barrier from the passageway initially at a variable rate until the barrier reaches a predetermined position at which pressure on the barrier is at least marginally equalized, and retracting the barrier at a constant rate after the barrier reaches the predetermined position, wherein the variable rate is lower than the constant rate.

Yet another embodiment includes a method of retracting a vapor barrier from a passageway. The method comprises retracting the barrier from the passageway with a drive system that exerts a retracting force on the barrier related to a resistance force opposing the retracting force, wherein the drive system has a defined power limit, stopping the drive system if the retracting force causes the drive system to reach the power limit, incrementing a first counter when the drive system is stopped, pausing a predetermined time period, and comparing the first counter to a first predetermined value. If the first counter has not reached the first predetermined value, retracting the barrier. If the first counter has reached the first predetermined value, moving the barrier toward a deployed position by exerting a deploying force on the barrier with the drive system. The method also includes incrementing a second counter when the drive system moves the barrier toward the deployed position, and comparing the second counter to a second predetermined value. If the second counter has reached the second predetermined value, the control system enters a fail state; and after moving the barrier toward the deployed position, retracts the barrier. The method can include pausing the predetermined time period is a function of at least one of the first or second counters, such that successive time periods are longer or shorter than previous time periods.

### BRIEF DESCRIPTION OF THE DRAWINGS

FIG. 1 is an isometric illustration of a barrier system in accordance with embodiments of the disclosure.

FIG. 2 is a partially schematic cross-sectional top elevation view of a portion of the barrier system shown in FIG. 1.

FIG. 3 is a partially schematic top view of a barrier under a pressure differential.

FIG. 4 is a graph of a plurality of acceleration profiles.

FIG. 5 is a flow-chart diagram of a control sequence for use with the barrier of FIG. 1.

FIG. 6 is a flow-chart diagram of a control sequence for use with the barrier of FIG. 1.

FIG. 7 is a flow-chart diagram of a control sequence for use with the barrier of FIG. 1.

### DETAILED DESCRIPTION

Aspects of the present disclosure are directed generally toward barrier systems and associated methods, including vapor and/or fire barrier systems. One aspect of the present disclosure is directed toward a barrier system that includes a flexible barrier movable into and out of position in a passageway in a structure, such as a building. The barrier is flexible and mitigates migration of smoke, vapor, and other harmful gasses through the passageway. The barrier is driven by a control system and a power source, such as a motor, and is guided into place by guide elements generally placed along sides of the passageway. Preventing the passage of smoke and vapor can result in creating a high pressure differential from one side of the barrier to the other, which can cause the flexible barrier to bow out of its relaxed plane. This bowing can impede the motion of the barrier system between the deployed and retracted positions, perhaps because the bowing causes increased friction between the guide elements and the barrier, because the pressure pulls at the guides, because of an obstruction, or for other reasons. The control system can raise the barrier toward the retracted position at a controlled acceleration profile to equalize pressure across the barrier by moving the barrier slowly at first until a portion of the pressure is released. The control system can then accelerate the barrier's movement toward the retracted position once the pressure has been equalized or marginally relieved.

Other aspects of the present disclosure are directed to an automatic retry mechanism for the barrier system. A motor that drives the barrier into and out of position in the passageway (e.g., between the deployed and retracted positions) includes an electrical current limiter that will stop the motor if the motor begins to draw too much current because of an obstruction. When the current level is exceeded and the barrier has not been retracted fully, a counter is incremented, the motor is stopped for a predetermined time, and then the motor is restarted and attempts to raise the barrier again. The cycle repeats until the counter reaches a predetermined number of attempts, in which case the system can enter a fail state.

Other aspects of the present disclosure are directed to a barrier system with a drive-down control mechanism. If barrier movement is inhibited and current limiters reach their limit and stop the motor's operation, the barrier can be driven back a predetermined distance toward its deployed position. After waiting a short time, the control system reverses the direction of movement of the barrier and attempts again to retract the barrier. A counter is incremented each iteration. This sequence repeats until the counter reaches a predetermined limit, at which point the barrier system can enter a fail state.

Various embodiments of the disclosure will now be described. The following description provides specific details for a thorough understanding and enabling description of these embodiments. One skilled in the art will understand, however, that the disclosure may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section. As used herein vapor includes gases or gases carrying particulates (e.g., solid and/or liquid particulates), such as smoke, fumes, smoke with soot particles, contaminated air, noxious fumes, and/or the like.

References throughout the specification to “one embodiment” or “an embodiment” means that a particular feature, structure, or characteristic described in connection with the embodiment and included in at least one embodiment of the present disclosure. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

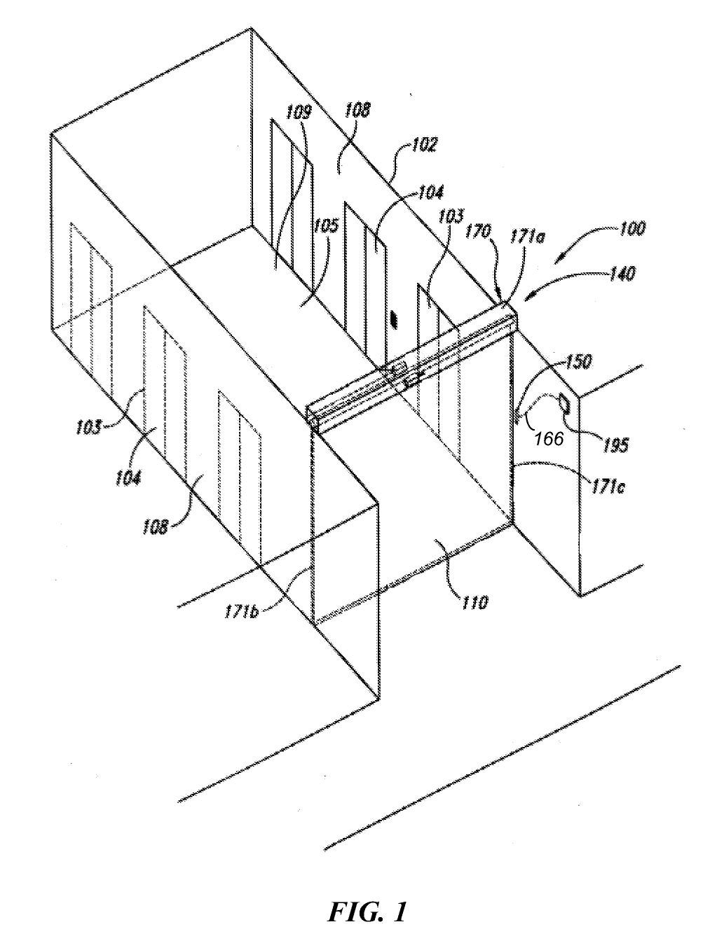

FIGS. 1-7 illustrate various features of a barrier system in accordance with various embodiments of the disclosure. FIG. 1 is an isometric illustration of the barrier system 100 that is located generally proximate to at least one passageway or opening 103 in a structure 102. In the illustrated embodiment, a plurality of openings 103 in the structure 102 are a hoistway openings between elevator shafts and a hallway, such as an elevator lobby 105 on a floor 109 of a building. In FIG. 1, movable elevator doors 104 can prevent access to the shaft when an elevator car is not present. However, as mentioned above, in the event of a fire these elevator doors may not sufficiently prevent vapors and/or fire from migrating through the opening 103. Accordingly, in the illustrated embodiment the barrier system 100 is positioned to sealably extend across the elevator lobby between two opposing walls 108, when the barrier system 100 is in a deployed position (shown in FIG. 1), thereby substantially sealing off the elevator lobby 105 and the elevator shafts from the rest of the floor. For example, the barrier system 100 can be positioned to at least approximately seal a passageway or opening in the building structure between the elevator lobby and the rest of the floor. In other embodiments, the barrier system can be positioned proximate to one or more of the opening(s) 103 so that in the deployed position the barrier system 100 at least approximately seals the associated elevator shaft(s) and the lobby 105 from one another.

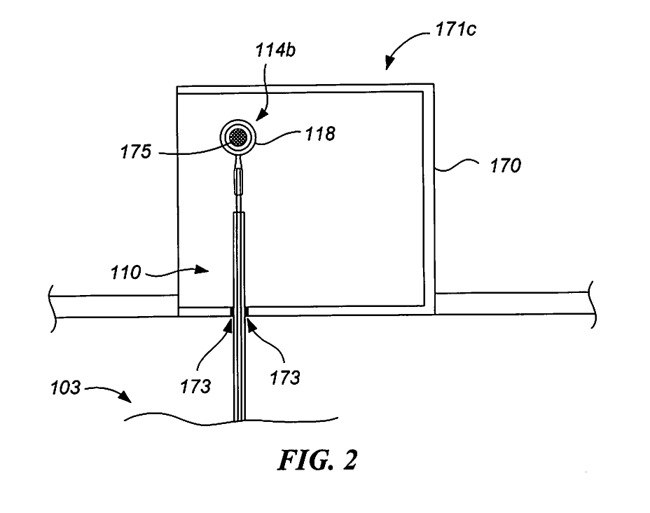

In selected embodiments, the barrier system 100 includes a flexible barrier 110 that can include a fabric smoke barrier or curtain and/or a fire barrier or curtain and in the deployed position can resist the movement or migration of vapors and/or fire (e.g., flames, burning materials, high temperature gases, and/or the like) between the elevator lobby and the rest of the floor. When the barrier 110 is in a retracted position (shown in FIG. 2), the portion of the elevator lobby is unblocked allowing an individual to pass to and from the elevators.

In FIG. 1, the barrier system 100 includes a drive assembly 140 coupled to the flexible barrier 110 to enable movement of the barrier between the retracted and deployed position. For example, in selected embodiments the drive assembly 140 can apply a force to move the barrier 110 between the retracted and deployed position. In other embodiments, the drive assembly 140 can allow other forces (including gravity) to move the barrier 110 between the deployed and retracted position, for example, by at least partially releasing a force resisting the movement of the barrier 110.

The barrier system 100 includes a control system 150 coupled to the drive assembly 140 and configured to command movement or operation of the drive assembly 140, which in turn can control movement of the barrier 110. In FIG. 1, the control system 150 is also operably coupled to at least one external device 195 associated with the barrier system 100, such as a fire alarm/detector, a smoke alarm/detector, an external monitoring system that monitors and displays the status of the barrier system 100 (or provides remote control of the system).

In selected embodiments, the control system 150 can include a computing system or computer and can be configured with instructions to control the movement of the drive assembly, to control the movement of the barrier, to communicate with external devices 195, to perform various monitoring tasks, to perform various calibration tasks, to provide or display the status of at least a portion of the barrier system 100, and/or the like. In certain embodiments, the control system 150 can include a display for displaying associated information and/or a control panel or key pad that allows a user to provide inputs to the control system 150 (e.g., to control the barrier system 100). The barrier system 100 can also include various pathways 166 for communicating information between components, transferring power (e.g., electrical power), and/or the like. In selected embodiments, these pathways can include wires, connectors, fiber optic cables/devices, wireless communication devices, and/or the like.

For example, in one embodiment the external device 195 can include a detector for detecting fire or selected vapor(s) (e.g., smoke). The detector can have at least two states including a first state where the detector does not sense the selected vapor(s) or fire (or where the detector senses the absence of the selected vapor(s) or fire) and a second state where the detector senses at least one of the selected vapor(s) and fire. The control system 150 can be configured to command the drive assembly 140 to enable movement of the barrier 110 toward the deployed position when the detector is in the second state. In certain embodiments, the control system 150 can be configured to command the drive assembly 140 to enable movement of the barrier 110 toward the retracted position when the detector is in the first state and the barrier 110 is not in the retracted position, for example, after the barrier 110 has been deployed in response to the detector sensing the selected vapor(s) and the selected vapor(s) have cleared.

In FIG. 1, the housing assembly 170 includes an upper portion 171a disposed in a ceiling structure, such as above an entry portion of the elevator lobby, and spanning between the opposing sidewalls of the elevator lobby. The housing assembly can include first and second side portions 171b and 171c disposed in or on the opposing sidewalls of the elevator lobby and below the ends of the upper portion 171a. As discussed in further detail below, in selected embodiments when the barrier 110 is in the deployed position the housing assembly 170 and barrier 110 can form a tortuous path that resists the movement of vapor(s) and/or fire (e.g., flames, high temperatures, etc.) between the elevator lobby 105 and the rest of the floor.

In selected embodiments the barrier 110 and barrier system 100 can be configured so that the barrier system 100 can meet various industry standards to qualify as a smoke partition, a fire partition, a fire barrier, a smoke barrier, and/or a fire wall (e.g., in accordance with standards associated with the International Building Code, International Code Congress, NPFA Life Safety Code, etc.). For instance, in one embodiment the barrier can include a flexible and foldable material that includes fiberglass that has been impregnated and/or coated with a flouropolymer such as a polytetraflouroethylene (PTFE) (e.g., such as Teflon®). In selected embodiments, a PTFE-coated material suitable for use as a smoke barrier can include CHEMFAB® (e.g., with a thickness of 0.003 to 0.004 inches), available from Saint-Gobain Performance Plastics Corporation of Elk Grove Village, Ill. In other embodiments, the barrier 110 can have other configurations, including being made from other materials and/or having other thicknesses.

FIG. 2 is a partially schematic cross-sectional top view illustration of a guide 175, a side portion 171c of the housing assembly 170, and a portion of the barrier 110. As shown in FIG. 2, certain embodiments include an engagement portion 118, which can be flexible and can be coupled or bonded to other portions of the barrier 110 (e.g., using a heat sealing process). For example, in selected embodiments the engagement portion 118 can be made from the same material as the rest of the barrier 110 (e.g., the material can be doubled over and coupled or bonded to other portions of the barrier 110 to form the engagement portion 118). In other embodiments, the engagement portion 118 can be made from a different material. In still other embodiments, the engagement portion 118 can have other arrangements. For example, in selected embodiments the second engagement portion 118 can be made by doubling over portions of barrier material to create a sleeve that slides up and down along the guide 175 as the barrier 110 moves into and out of position. Other engagement configurations between the engagement portion 118 are possible. For example, the guide 175 can comprise a slot, and the engagement portion 118 can comprise a T-shaped protrusion that fits within the slot to guide the barrier. In selected embodiments, a part of at least one of the engagement portion 118 and the guide 175 can include a non-stick or slippery surface (e.g., such as a PTFE material) to help facilitate movement of the engagement portion 118 relative to the guide 175. In addition, other embodiments include an engagement portion 118 with rigid or semi-rigid loops or rings (e.g., with or without one or more bearing arrangements). In still other embodiments, the engagement portion 118 and guide 175 can include one or more linear bearings.

In FIG. 2, the second side portion 171c of the housing assembly 170 is configured to resist the movement of vapor(s) and/or fire through the barrier 110. For example, in the illustrated embodiment the second side portion 171c of the housing assembly 170 includes one or more sections 172 that enclose the side 114 of the barrier 110 and the guide 175 with a small opening through which a portion of the barrier extends toward the side 114 of the barrier 110. This small opening (e.g., a vertical slot) in combination with the barrier 110 and the rest of the second side portion 171c of the housing assembly 170 creates a torturous path for vapor(s) and/or fire to negotiate. Additionally, in selected embodiments one or more sealing elements 173 can further aid in resisting the penetration of vapor(s) and/or fire into and/or out of the second side portion 171c of the housing assembly 170. In certain embodiments these sealing elements 173 can include resilient blade-like materials that contact portions of the barrier 110. In other embodiments, the sealing elements 173 can have other arrangements. For example, in other embodiments the sealing elements can include foam, rubber, silicon, fabric, composite, plastic, and/or other materials and can be configured as wipers, brushes, blade seals, and/or the like. Although for clarity of discussion FIG. 2 shows one side of the barrier 110 and housing assembly 170, it is to be appreciated that other sides can have similar or different configurations.

Accordingly, as discussed above, in selected embodiments the barrier system 100 can resist the migration of vapor(s) and/or fire through the barrier 110 when the barrier 110 is in the deployed position. For example, as discussed above, when the flexible barrier 110 is in the deployed position, the barrier 110 can at least approximately seal against the floor of the elevator lobby 105 and/or a surface of the structure. Additionally, portions of the housing assembly 170 in combination with the barrier 110 can resist the migration of vapor(s) and/or fire through the barrier 110. Therefore, in certain embodiments the barrier system 100 can at least approximately seal the elevator lobby 105 and resist the migration of vapor(s) and/or fire through the barrier 110 when the flexible barrier 110 is in the deployed position.

As discussed above, a control system 150 includes a computer or computing system configured with instructions to enable and control movement of the barrier. Additionally, in selected embodiments the control system 150 can perform other functions, including supplying electrical power to other components (e.g., the control system 150 can supply power from a power supply to the external device 195), monitoring various barrier system components, monitoring external devices, and/or calibrating various components associated with the barrier system. For example, in certain embodiments the control system 150 can command the drive assembly 140 to enable movement or to move the barrier toward the deployed and retracted positions based on the information provided by the external device 195 and/or other systems.

For instance, as discussed above, in selected embodiments where the external device 195 includes a smoke or fire alarm/detector, the control system 150 can be configured to command the drive assembly 140 to enable movement of the barrier 110 toward the deployed position when the detector senses fire, smoke, and/or other types of selected vapor(s) (e.g., is in the second state). The control system 150 can also be configured to command the drive assembly 140 to enable movement of the barrier 110 toward the retracted position when, as an example, the detector does not sense fire, smoke, or selected vapor(s) (e.g., is in the first state), and the barrier 110 is not in the retracted position. Accordingly, the control system 150 can be configured with instructions to deploy the barrier 110 when a vapor and/or fire event is sensed (e.g., when the barrier 110 is not in the deployed position) and retract the barrier 110 when the vapor and/or smoke event has cleared.

In still other embodiments, the control system 150 can be configured with instructions for performing other functions and/or with other control logic. For example, in selected embodiments the control system 150 can be configured to perform monitoring, backup, and/or calibration functions. For instance, in selected embodiments the control system 150 can be configured to monitor the health of various components associated with the barrier system and/or report the status of various components associated with the barrier system to other systems.

For example, in selected embodiments the control system 150 can monitor components associated with the barrier system external to the barrier system including a power source and the external device 195. For instance, in selected embodiments the control system 150 can monitor the external device 195 by sending a signal to the external device 195 and/or receiving a signal from the external device 195. The signal(s) can be used to determine whether the external device 195 is connected to the barrier system 100 via pathway(s) 166, whether the external device is powered, whether the external device has a fault (e.g., is malfunctioning), what fault(s) the external device has experienced, and/or the like.

In other embodiments, the control system 150 can monitor other barrier system components, including components that comprise the barrier system 100 itself. For example, in certain embodiments the control system 150 can monitor the health of a power source, the drive assembly 140, and/or the pathway 166. For example, in selected embodiments the control system 150 can send and/or receive signals to determine battery charge state(s), whether the battery charging unit(s) is/are working, whether one or more batteries have overheated, and/or the like. In other embodiments, the control system can monitor various components for an overload condition.

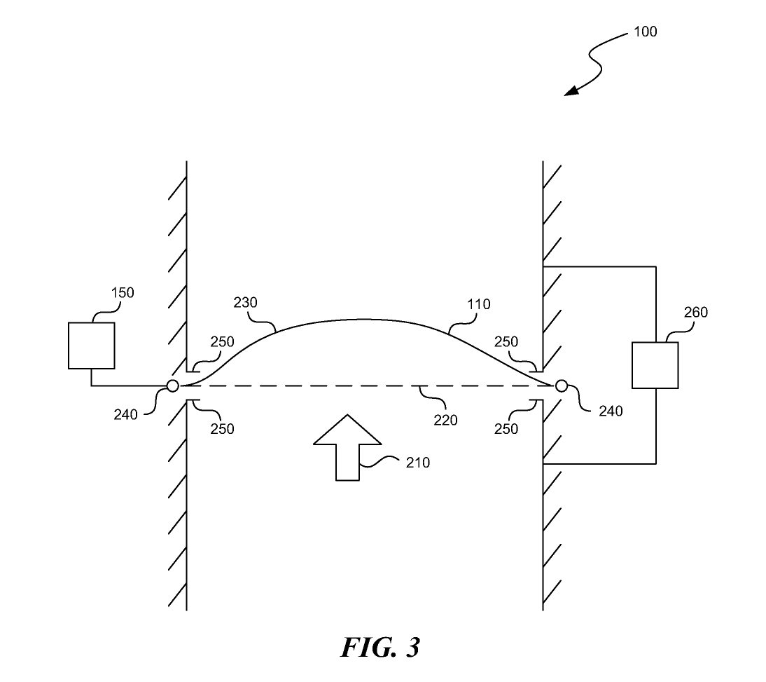

FIG. 3 illustrates additional embodiments of the barrier system 100 according to the present disclosure. The seal created by the deployed barrier 110 can cause significant pressure 210 to build up on one side of the barrier 110. In the absence of this pressure gradient, the barrier 110 generally lies in a relaxed plane 220. In several embodiments, the barrier 110 is made of a flexible material which can bow away from the relaxed plane due to an elevated pressure 210 on one side of the barrier compared to the pressure on the other side of the barrier (i.e., the pressure differential across the barrier). Accordingly the barrier can take a flexed shape 230 that can inhibit normal movement of the barrier 110 toward or away from the deployed position. For example, the flexed barrier shape 230 may pull on the guides 240, causing greater friction between the barrier 110 and the guides 240. Also, a portion of the barrier 110 in the flexed shape can contact a portion of the housing 250, which may also inhibit the desired barrier movement, such as from the deployed position toward the retracted position or an intermediate position between the retracted and deployed positions. To ensure normal barrier movement, the control system 150 of the illustrated embodiment is configured to take certain steps to ensure that the barrier 110 can move freely despite a pressure gradient, or to alleviate the pressure gradient. For example, as discussed in greater detail below, the system 100 can include a pressure-release valve or hatch 260 to equalize pressure across the barrier 110, In addition, the system 100 can alter an acceleration profile for the barrier 110.

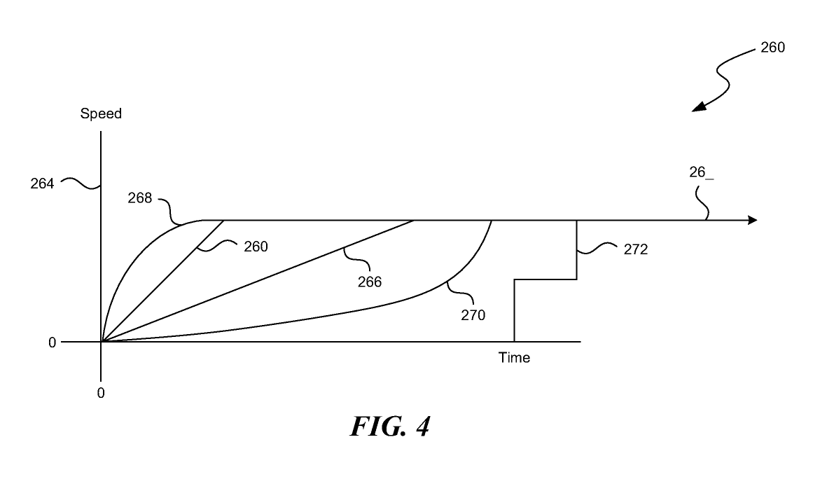

FIG. 4 is a graph of barrier speed against time showing several acceleration profiles 260 for use with the barrier system 100 in accordance with several embodiments of the present disclosure. In a ramped profile 262, the barrier is moved at a reduced but increasing speed for a predetermined time or distance before reaching full system speed 264, which in selected embodiments is approximately one foot per second. This allows some pressure to dissipate (e.g., by heat, air or other gasses moving under the barrier 110 to decrease the pressure differential across the barrier) while the barrier moves more slowly, thus encountering reduced friction forces. Other acceleration profiles are possible, including ramped profiles of different rates 266, parabolic profiles 268 and 270, and a stepped profile 272. It is to be appreciated that these profiles can be combined or otherwise interchanged. In addition, the graph of FIG. 4 does not limit the present disclosure to any given movement speed for any of the profiles shown. Barrier systems 100 in accordance with the present disclosure may have differing power capabilities, and can be employed in various environments where different speeds and acceleration profiles are possible, all of which are encompassed by the present disclosure.

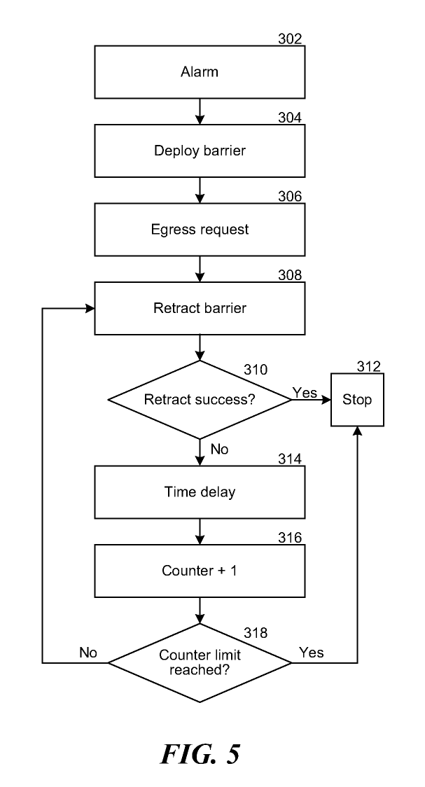

FIG. 5 illustrates a flow-chart diagram of a control sequence 300 of several embodiments in which the control system 150 can move the barrier 110 to overcome an obstruction to normal movement. In the illustrated embodiment, an alarm 302 triggers the barrier to deploy 304 from the retracted position to the deployed position. When the barrier is in or is adjacent to the deployed position, as an example, an egress request 306 can be provided from the control system 150, such as when the control system receives an egress request from an occupant near the barrier 110. For example, the external device 195 shown in FIG. 1 can comprise a keypad or other input device through which the occupant can make the egress request 306. In response, the control system 150 initiates movement of the barrier 308 to retract the barrier toward the retracted position. The success of the retraction is judged 310: if successful, the control sequence 300 ends 312; if unsuccessful, the control system 150 can wait a predetermined time 314. One measure of success is whether electrical current limiters coupled to the motor are triggered by a given current threshold, causing the motors to stop before reaching the retracted position. The control system 150 can also increment a counter 316 to record iterations. If the counter has reached its limit 318, the sequence stops 312. If not, the control system can issue another command to retract the barrier 308. With this control sequence 300, the control system 150 allows a short, predetermined time (1 second, 2 seconds, 60 seconds, etc.) for the obstruction to clear. For example, if excess pressure is the cause of the obstruction, the time delay 314 can allow some of the pressure to dissipate either because, as an example, some heat, air and/or other gases escapes to the other side of the barrier 110, or for some other reason. Either way, the sequence 300 is a simple, effective way to ensure that the barrier 110 can be raised, for example, by reducing the pressure differential across the barrier, thereby allowing the barrier to at least partially relax from the flexed position toward the relaxed plane, so as to reduce any frictional interference to the barrier's movement.

It is to be appreciated that various variables, such as the time delay and the counter limit can vary. In addition, the time delay can vary as a function of the counter position. For example, the first time delay may be short (e.g., 1 second), but after a few attempts the time delay can increase (e.g., 60 or 90 seconds) in hopes that a longer time delay allows the obstruction to resolved or alleviated.

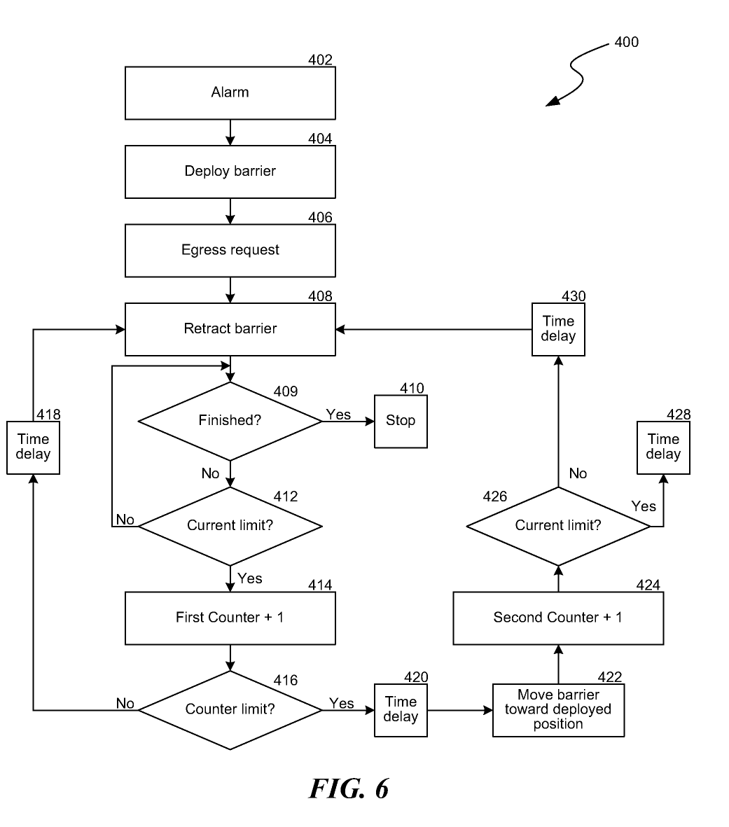

FIG. 6 illustrates another control sequence 400 for the control system 150 according to several embodiments of the present disclosure. An alarm 402 is received and the control system causes the barrier to deploy 404 to the deployed position. Sometime after the barrier is deployed, an egress request 406 is received that causes the control system 150 to retract the barrier 408 away from the deployed position. If judged successful 409 (e.g., if the barrier moves a sufficient distance from the deployed position or to the fully retracted position), the egress sequence exits 410. If unsuccessful, a current limiter is judged for whether the electrical current in a motor has exceeded a threshold 412. If the limit has not been reached, the control system 150 continues operating and queries again whether the barrier has been successfully retracted 408. If the current limit has been reached, a first counter can be incremented 414. If the first counter has not reached a predetermined limit 416 (e.g., 2, 3, 4, etc.), the control system 150 executes a time delay 418 (e.g., 1 second, 2 seconds, 60 seconds, etc.) then attempts again to retract the barrier 408. If the counter has reached its limit, the control system 150 executes a time delay 420, then reversed the barrier's motion and moves the barrier 110 back toward the deployed position 422. The barrier 110 can be moved a small, predetermined distance, or can be deployed until the barrier 110 reaches the fully deployed position. One advantage of this feature is that an obstruction to the barrier 110 may be overcome by reversing the movement of the barrier 110. Next, a second counter is incremented 424. If the counter limit 426 has been reached, the control system 150 stops 428; otherwise, a time delay 430 is executed before the control system 150 attempts again to retract the barrier 408.

The first counter 414 and the second counter 424 may have the same limit, but are not necessarily the same. The two counters may be independent, or cumulative. In addition, the various time delays 418, 420, and 430 can have the same duration, but need not necessarily have the same duration. The time delays can also run independently or cumulatively. Also, the time delays can be a function of the counter position (any one or both of the counters), such that later iterations have a longer or shorter time delay period than previous iterations. It is to be appreciated that various alterations and combinations of portions of the control sequence 400 are possible without departing from the scope of the present disclosure.

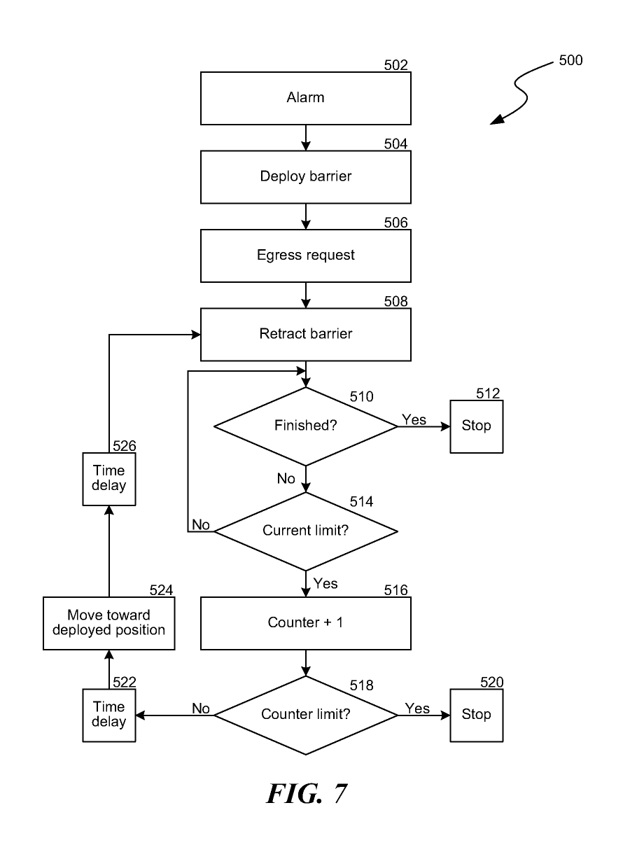

FIG. 7 illustrates an alternative control sequence 500 in accordance with another embodiment of the present disclosure. An alarm 502 is received and the controls system causes the barrier to deploy 504. Sometime after the barrier is moved to the deployed position, an egress request 506 is received that causes the control system 150 to retract the barrier 508. If successful 510, the sequence exits 512. If unsuccessful, a judgment is made whether the current in a motor has exceeded a predetermined threshold 514. If not, the sequence 500 continues until the barrier 110 successfully retracts, or the current limit is reached. When the current limit is reached, a counter 516 is incremented, and if the counter has reached a predetermined limit (e.g., 2, 3, 4, 10, etc.), the control system 150 stops and the sequence 500 ends. If the counter limit has not been reached, the control system 150 executes a time delay 522, and then moves the barrier 110 toward the deployed position 524. The motion of the barrier 110 can be reversed and moved downward a small or large distance, or can be moved downward until the barrier reaches the fully deployed position. After moving downward, another time delay 526 is executed before attempting again to retract the barrier 508.

In addition to the control sequences illustrated above with reference to FIGS. 5-7, it is to be appreciated that other control sequences are within the scope of the present disclosure. For example, certain elements can be omitted, repeated, or rearranged. Also, the system 100 can include a pressure-release valve or hatch 260 (shown in FIG. 3) that can release pressurized fluid across the barrier 110 to equalize the pressure to ease barrier movement. The hatch 260 can be through the barrier 110, or through an adjacent structure such as a wall or a door. The hatch 260 can be operated in response to sensing that the barrier 110 has encountered resistance. In some embodiments, the hatch 260 can infer that movement of the barrier 110 has been impeded if a current level in a motor exceeds a predetermined threshold limit. The hatch 260 can open in response to release the pressure, after which the movement can resume.

In other embodiments, the barrier system 100 can have various other arrangements. For example, although in illustrated embodiments the barrier is shown moving in vertical plane between the retracted and deployed positions. In other embodiments the barrier system can have other orientations. For example, in selected embodiments the second end of the barrier can move in a horizontal plane between the retracted and the deployed positions. Additionally, although in the illustrated embodiment the barrier is made from a flexible material, in other embodiments the barrier can have other configurations. For example, in other embodiments at least a portion of the barrier can have rigid or semi-rigid segments or portions. Furthermore, although in the illustrated embodiment the barrier system is shown associated with a structure that includes a building, in other embodiments the barrier system can be associated with other structures. For example, in one embodiment the barrier system is positioned to cover an opening in a vehicle, such as a ship.

The above-detailed embodiments of the disclosure are not intended to be exhaustive or to limit the disclosure to the precise form disclosed above. Specific embodiments of, and examples for, the disclosure are described above for illustrative purposes, but those skilled in the relevant art will recognize that various equivalent modifications are possible within the scope of the disclosure. For example, whereas steps are presented in a given order, alternative embodiments may perform steps in a different order. The various aspects of embodiments described herein can be combined and/or eliminated to provide further embodiments. Although advantages associated with certain embodiments of the disclosure have been described in the context of those embodiments, other embodiments may also exhibit such advantages. Additionally, not all embodiments need necessarily exhibit such advantages to fall within the scope of the disclosure.

Unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Additionally, the words “herein,” “above,” “below,” and words of similar import, when used in this application, shall refer to this application as a whole and not to any particular portions of this application. Use of the word “or” in reference to a list of items is intended to cover a) any of the items in the list, b) all of the items in the list, and c) any combination of the items in the list.

In general, the terms used in the following claims should not be construed to limit the invention to the specific embodiments disclosed in the specification unless the above-detailed description explicitly defines such terms. In addition, the inventors contemplate various aspects of the disclosure in any number of claim forms. Accordingly, the inventors reserve the right to add claims after filing the application to pursue such additional claim forms for other aspects of the disclosure.

I/We claim:

1. A barrier system, comprising:
a flexible barrier having a leading edge, a trailing edge, and two side edges, the barrier being configured to deploy across a passage to divide the passage into a first region and a second region to inhibit migration of vapor through the passage;
a plurality of guide elements configured to engage the two side edges to guide the flexible barrier toward a deployed position across the passage;
a drive mechanism coupled to the flexible barrier and configured to deploy and retract the flexible barrier, wherein the drive mechanism draws electrical current to move the flexible barrier to and from the deployed position, and wherein the electrical current drawn by the drive mechanism is related to a motion-resistance force opposing barrier movement;
a control system operatively coupled to the drive mechanism and configured to receive an egress request, the control system being configured to activate the drive mechanism to retract the flexible barrier away from the deployed position in response to the egress request;
a current limit monitor coupled to the control system and configured to monitor the current drawn by the drive mechanism, wherein the control system is configured to stop movement of the flexible barrier if the electrical current drawn by the drive mechanism exceeds a threshold value related to the motion-resistant force, the control system being further configured to wait a predetermined time period before reactivating the drive mechanism resuming movement of the flexible barrier.

2. The barrier system of claim 1, further comprising a manually operated switch switch positionable remote from the barrier and configured to provide an egress request signal to the control system, wherein the switch, when activated, transmits the egress request signal to the control system.

3. The barrier system of claim 1 wherein the predetermined time period is between approximately 1 and 2 seconds.

4. The barrier system of claim 1 wherein the control system is further configured such that after waiting the predetermined time period, the control system reversed direction of the drive mechanism to move the flexible barrier toward a deployed position for a selected duration, and then reverses the direction of the drive mechanism and attempts to retract the barrier away from the deployed position.

5. The barrier system of claim 1 wherein the barrier is configured to be positioned in a ceiling above the passageway and is configured to deploy downward such that the leading edge contacts a floor when in the deployed position.

6. The barrier system of claim 1 wherein the barrier is configured to be positioned in a wall adjacent to a generally vertical passageway and is configured to deploy generally horizontally such that the leading edge contacts an opposing wall when in the deployed position.

7. A method of permitting egress through a flexible barrier deployed in a passageway to inhibit the migration of vapor through the passageway, wherein the barrier divides the passageway between a first and a second region, the method comprising:
receiving an egress request to move the barrier toward a retracted position;
moving the barrier toward the retracted position with a drive mechanism in response to the egress request;
monitoring a current level in the drive mechanism;
stopping the drive mechanism if the current level exceeds a predetermined threshold;
waiting a predetermined time period; and
resuming the drive mechanism for moving the barrier toward the retracted position.

8. The method of claim 7, further comprising:
incrementing a counter when the drive mechanism is stopped; and
entering a fail state in which the drive mechanism is stopped.

9. The method of claim 8 wherein the fail state further comprises notifying an external system of the fail state.

10. The method of claim 7, further comprising opening a pressure-release valve across the barrier after waiting the predetermined time period and before resuming the drive mechanism.

11. The method of claim 7 wherein the predetermined time period comprises a first predetermined time period, and wherein resuming barrier movement comprises:
moving the barrier toward the deployed position a predetermined distance;
pausing barrier movement for a second predetermined time period; and
moving the barrier toward the retracted position.

12. The method of claim 7 wherein the predetermined time period comprises at least 1 second.

13. The method of claim 7 wherein the predetermined time period comprises between 0 and 5 seconds.

14. The method of claim 7 wherein after waiting the predetermined time period, the method further comprises:
repeating moving the barrier toward the retracted position, monitoring the current level, and stopping movement of the barrier if the current level exceeds a predetermined threshold;
incrementing a counter for each repetition; and
ceasing the repetition when the counter reaches a predetermined limit.

15. The method of claim 14, further comprising at least one of increasing or decreasing the predetermined time period for each repetition.

16. The method of claim 7 wherein the current level in the drive mechanism is configured to increase if movement of the barrier is obstructed.

17. The method of claim 7 wherein moving the barrier toward the retracted position comprises relieving a pressure differential between the first and second regions.

18. A method for retracting a pressurized vapor barrier from a passageway, the method comprising:
receiving an egress request from an external source;
retracting the barrier from the passageway initially at a variable rate until the barrier reaches a predetermined position at which pressure on the barrier is at least marginally equalized; and
retracting the barrier at a constant rate after the barrier reaches the predetermined position, wherein the variable rate is lower than the constant rate.

19. The method of claim 18 wherein the variable rate comprises a monotonically increasing rate until the variable rate reaches the constant rate.

20. The method of claim 18 wherein the variable rate comprises a stepped rate, wherein the stepped rate comprises at least one rate lower than the constant rate.

21. The method of claim 18 wherein the variable rate comprises at least one of a non-linearly increasing rate or a non-linearly decreasing rate.

22. The method of claim 18 wherein the variable rate comprises a linearly increasing rate until the variable rate reaches the constant rate.

23. A method of retracting a vapor barrier from a passageway, the method comprising:
retracting the barrier from the passageway with a drive system that exerts a retracting force on the barrier related to a resistance force opposing the retracting force, wherein the drive system has a defined power limit;
stopping the drive system if the retracting force causes the drive system to reach the power limit;
incrementing a first counter when the drive system is stopped;
pausing a predetermined time period;
comparing the first counter to a first predetermined value;
if the first counter has not reached the first predetermined value, retracting the barrier;
if the first counter has reached the first predetermined value, moving the barrier toward a deployed position by exerting a deploying force on the barrier with the drive system;
incrementing a second counter when the drive system moves the barrier toward the deployed position;
comparing the second counter to a second predetermined value;
if the second counter has reached the second predetermined value, entering a fail state; and
after moving the barrier toward the deployed position, retracting the barrier.

23. The method of claim 23 wherein the drive system comprises an electrical motor configured to draw electrical current generally proportional to the resistance force.

25. The method of claim 23 wherein the power limit is below a safe operating limit of the drive system, such that the drive system reaches the defined power limit before substantially risking harm to the drive system.

26. The method of claim 23 wherein the first and second counters comprise electronic counters stored in a computer-readable memory.

27. The method of claim 23 wherein the pausing the predetermined time period comprises pausing between approximately 1 and 2 seconds.

28. The method of claim 23 wherein the predetermined time period is a function of at least one of the first or second counters, such that successive time periods are longer or shorter than previous time periods.

29. The method of claim 23 wherein retracting the barrier from the passageway comprises:
moving the barrier initially at a variable rate until the barrier reaches a predetermined position at which pressure on the barrier is at least marginally equalized; and
retracting the barrier at a constant rate after the barrier reaches the predetermined position, wherein the variable rate is lower than the constant rate.

30. The method of claim 29 wherein the variable rate comprises a linearly increasing rate until the barrier reaches the constant rate.
